(19) United States
(12) Patent Application Publication
(10) Pub. No.: US 2010/0133875 A1
(43) Pub. Date: Jun. 3, 2010

(54) TRIM PIECE FOR A DOOR OF A MOTOR VEHICLE

(75) Inventor: Jean Charles Bouillon, La Queue Lez Yvelines (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 12/600,381

(22) PCT Filed: May 5, 2008
(86) PCT No.: PCT/FR2008/050785

§ 371 Date: Jan. 15, 2010

(30) Foreign Application Priority Data
May 15, 2007 (FR) 0703494

(51) Int. Cl. B60J 5/04

(52) U.S. Cl. 296/187.01; 49/507

(57) ABSTRACT

A fitting member for a door of an automobile, including a first attachment mechanism for direct attachment to the sheet metal of the door, the attachment being implemented in a central portion of the door.

The present invention relates to the field of motor vehicle door trim.

Door trim is designed to cover the door structures on the inside of a vehicle for reasons of comfort, ergonomics and appearance. For this purpose they are attached at a number of points to the sheet metal structures of the door.

They are usually attached to the edges of the door structures. In this way the edges of the trim pieces being close to the attachments, are held rigidly against the door structures.

Door trim usually includes a handle which is used among other things for closing the door. This handle is usually roughly in the middle of the door trim panel.

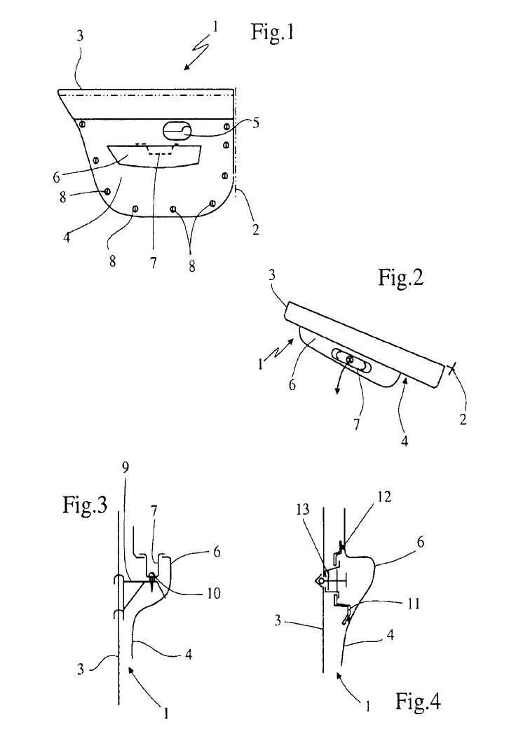

FIGS. 1 and 2 show a known motor vehicle rear door structure. The rear door 1 is hinged to the vehicle body about an approximately vertical axis 2. The door chiefly comprises a structure 3 made of sheet metal and covered on its inside with a trim panel 4 (also known as trim). The trim panel is attached to the door structure by attachment means 8 such as staples applied to the edge of the trim. This trim contains an opening for a control lever for opening the door 5. A hump forming an arm rest 6 is also molded into the trim. A recessed box 7 is arranged on this arm rest. This box provides the handle function described earlier, i.e. a user will use it to close the door of the vehicle.

Given the nature of the materials used for door trim (usually plastics) and the location of their points of attachment to the door structure, it is not an option to have the door trim panel carry the forces applied to the handle at this point on its own.

One arrangement, shown in FIG. 3, is therefore to have the forces applied to the recessed box directed into the sheet metal structure of the door through a bracket 9 connected both to the sheet metal structure of the door, by stapling for example, and to the recessed box by means of a screw 10.

Another arrangement shown in FIG. 4, is to connect the trim in the vicinity of the recessed box to a box 11 by means of a bead of glue 12. This box 11 comprises a snap-fastening attachment means that locks the box by a mechanical connection to the sheet metal structure of the door.

By these means, the mechanical actions by the user on the door handle are transmitted only a short distance from the handle to a sheet metal part of the door structure and the trim suffers little or no deformation from the mechanical actions of closing the door.

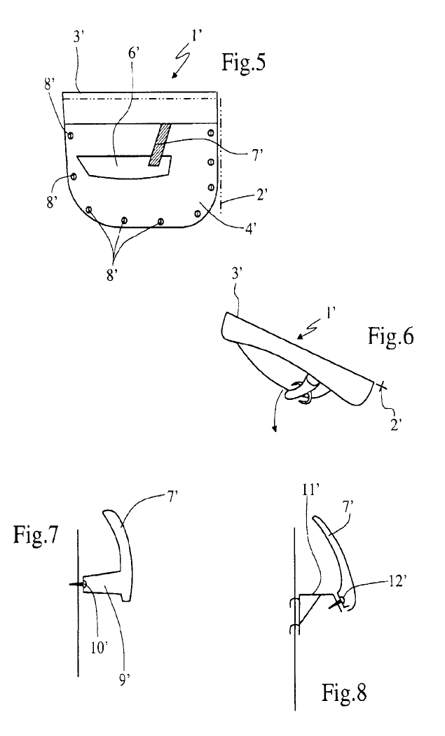

FIGS. 5 and 6 illustrate a known motor vehicle front door structure. The front door 1′ is hinged to the vehicle body about an approximately vertical axis 2′. The door comprises principally a structure 3′ made of sheet metal and covered on its inside by a trim panel 4′. The trim panel is attached to the door structure by attachment means 8′ such as staples around the edge of the trim. A hump forming an arm rest 6′ is molded into the trim. A handle 7′ is attached by both ends to the door. A user will pull this handle to close the door of the vehicle.

Given the nature of the materials used for door trim (usually plastics) and the location of their points of attachment to the door structure, it is not an option to have the door trim panel carry the forces applied to the handle at this point on its own.

One arrangement, shown in FIG. 7, is therefore to provide at one end of the handle a long hollow shaft 9′ by which to attach the handle directly to the metal structure of the door with a screw 10′. Forces applied to the handle are in this way directly applied to the metal structure of the door. This arrangement creates assembly problems: the component into which the screw is being screwed at the bottom of the shaft is damaged with a relatively high degree of frequency because the worker cannot see what he is doing.

Another arrangement, shown in FIG. 8, is to have the forces applied to the handle directed into the sheet metal structure of the door through a bracket 11′ connected both to the sheet metal structure of the door, by stapling for example, and to the handle by means of a screw 12′.

However, there are problems with these arrangements. In particular, they require, in some cases, the attachment of components between the trim piece and the door structure. This not only creates costs in producing the additional parts but also costs of assembling them. In other cases they complicate the assembly and constrain the structure and the architecture.

The object of the invention is to provide a door trim piece that avoids the problems described above and improves on the door trim known from the prior art. In particular, the door trim piece according to the invention minimizes the number of components of a motor vehicle door and optimizes the costs, assembly constraints and architectural constraints of motor vehicle doors.

According to the invention, the trim piece for a door of a motor vehicle is characterized in that it comprises a first attachment means for its direct connection to a sheet metal part of the door, this connection being formed in a central part of this door.

The first attachment means may comprise a snap-fastening means that locks the trim piece to the sheet metal part.

The trim piece may include a well.

The trim piece may comprise a second attachment means for attaching a door handle.

The trim piece may comprise a third attachment means for attaching another door trim piece.

The door for a motor vehicle, according to the invention, comprises a trim piece as defined above.

The motor vehicle according to the invention comprises a door as defined above.

The attached drawing shows by way of example two embodiments of a door trim piece according to the invention.

FIG. 1 is a diagram of the inside of a known prior-art motor vehicle rear door.

FIG. 2 is a top diagram of this motor vehicle rear door.

FIG. 3 is a partial cross section through this motor vehicle rear door. This diagram details one arrangement for carrying the forces applied to a door handle.

FIG. 4 is a partial cross section through this motor vehicle rear door. This diagram details a second arrangement for directing the forces applied to the handle.

FIG. 5 is a diagram of the inside of a known prior-art motor vehicle front door.

FIG. 6 is a top diagram of this motor vehicle front door.

FIG. 7 is a partial cross section through this motor vehicle front door. This diagram details one arrangement for directing the forces applied to a door handle.

FIG. 8 is a partial cross section through this motor vehicle front door. This diagram details a second arrangement for directing the forces applied to the handle.

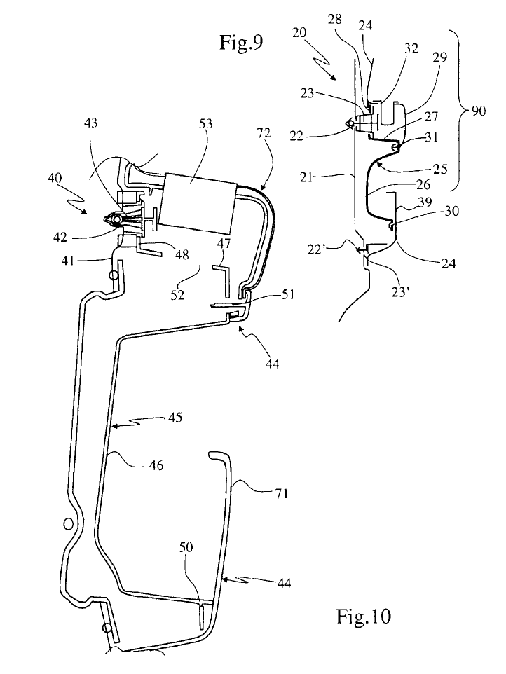

FIG. 9 is a partial cross section through a first motor vehicle rear door structure. This structure comprises one embodiment of a trim piece according to the invention.

FIG. 10 is a vertical cross section through a second motor vehicle front door structure. This structure comprises an embodiment of a trim piece according to the invention.

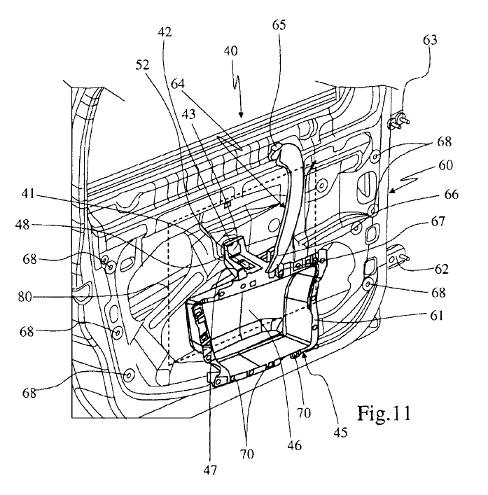

FIG. 11 is a perspective view of the second door structure.

A first embodiment of a motor vehicle rear door 20 is described with reference to FIG. 9. This door comprises a rigid, e.g. metallic, structure comprising a sheet metal part 21. Openings 22 and 22′ are made in this sheet metal part for attaching door trim pieces.

In particular, a first trim piece 25 and a second trim piece 24 are attached to this structure. The first trim piece consists of a well 25. It is generally dish-shaped 26 and is mounted vertically. It comprises, extending from its edge, a leg 27 extending approximately horizontally at its top. This leg ends in a portion 28 which runs approximately vertically or approximately parallel to the sheet metal part 21. This portion 28 and the opening 22 are used with a first attachment means 23 to attach the first trim piece to the structure of the door. This connection is formed in a central part 90 of the door. The attachment means may for example be a snap-fastening means that locks the first trim piece to the door structure. This attachment could also be created by, for example, screwing a screw into the sheet metal part 21 through the portion 28, or by any other means of connecting the first trim piece directly to the sheet metal part. The first trim piece also includes at its edge second attachment means 30 and third attachment means 31 for attaching other components to it.

This first trim piece is the first, or one of the first, trim pieces to be mounted on the door structure. The second trim piece 24 which is in the form of a panel covering the greater part of the door structure, is then mounted on the door structure. It is assembled to the structure by attachment means such as staples 23′ engaged in openings 22′ provided in the sheet metal part 21. The second trim piece is also connected to the first trim piece by staples engaging with the second attachment means 30 referred to earlier. When combined with the first trim piece, this second trim piece creates with its wall 39 a storage space in the door of the vehicle. Objects placed in the storage space will be kept in by the wall 39.

A third trim piece 29 is then mounted on the first two pieces at the point where the first trim piece is attached to the sheet metal part of the door structure. This third trim piece has a recessed box fitted to it to act as a handle 32 chiefly for closing the door. This third piece is attached to the first two pieces notably by means of the third attachment means 31 provided on the first trim piece. Forces applied to the handle are thus carried by the door trim in the immediate vicinity of its central attachment to the sheet metal part of the door structure, in other words to a location where the trim is relatively rigid. Mechanical forces applied to the door handle therefore cause very little deformation of the trim.

A second embodiment of a motor vehicle front door 40 is described with reference to FIGS. 10 and 11. This door comprises a rigid, e.g. metallic, structure comprising a sheet metal part 41. Openings 68 and 42 are made in this sheet metal part for attaching door trim pieces.

In particular, a first trim piece 45 and a second trim piece 44 are attached to this structure. The first trim piece consists of a well 45. It is generally dish-shaped 46 and is mounted vertically. It comprises, extending from its edge, a leg 47 extending approximately horizontally at its top. This leg ends in a portion 48 which runs approximately vertically or approximately parallel to the sheet metal part 41. This portion 48 and the opening 42 are used with a first attachment means 43 to attach the first trim piece to the structure of the door. This connection is formed in a central part 80 of the door. The attachment means may for example be a snap-fastening means that locks the first trim piece to the door structure. This attachment could also be created by, for example, screwing a screw into the sheet metal part 41 through the portion 48, or by any other means of connecting the first trim piece directly to the sheet metal part. The first trim piece also includes at its edge second attachment means 67 and third attachment means 70 for attaching other components to it.

This first trim piece is the first, or one of the first, trim pieces to be mounted on the door structure. The second trim piece 44 which is in the form of a panel covering the greater part of the door structure, is then mounted on the door structure. It is assembled to the structure by attachment means such as staples (not shown) engaged in openings 68 provided in the sheet metal part 41. The second trim piece is also connected to the first trim piece by staples engaging with the third attachment means 70 referred to earlier. When combined with the first trim piece, this second trim piece creates with its wall 71 a storage space in the door of the vehicle. Objects placed in the storage space will be kept in by the wall 71.

A handle 64 is then mounted on the door. It is attached to both ends. Its top end is attached to the second trim piece at the top of the door. Its bottom end is attached at the top of the first trim piece, close to the leg 47. To this end, the first trim piece has a roughly vertical leg 67 at its edge. It is to this leg 67 that the lower part of the handle is attached. Consequently, forces applied to the handle are carried by the door trim in the vicinity of its central point of attachment to the sheet metal part of the door structure, in other words to a location where the trim is relatively rigid. The trim therefore deforms only very slightly when mechanical forces are applied to the handle.

It will be seen that various different constraints of architecture can easily be met by modifying the shapes of the leg 47. For example, a recess 52 may be formed in it so that an electric window control means 53 can be installed next to the handle. Such an architecture, it may be noted, was made impossible in one prior-art arrangement in which the bottom end of the handle had a shaft to the bottom of which a screw was screwed.

As pointed out previously, the invention has a number of advantages.

### Cost Advantages:

fewer parts due to elimination of the intermediate attachment parts of the trim,
simpler assembly.

### Geometrical, Structural and Architectural Advantages:

greater structural and geometrical sturdiness,
more compact size,
shapes more easily modifiable to satisfy design, ergonomic and architectural constraints.

In this application, “trim piece” means any part attached to the rigid structure of the door and at least partially visible from inside the vehicle.

In this application, “central part of the door” means a region having a shape homothetic to that of the part under glass of the door, centered on the center of the part under glass of the door and an area representing not more than 25%, and preferably not more than 10%, of the part under glass of the door.

1-7. (canceled)

8. A trim piece for a door of a motor vehicle, comprising:
a first attachment means for its direct connection to a sheet metal part of the door, the connection being formed in a central part of the door.

9. The trim piece as claimed in claim 8, wherein the first attachment means comprises a snap-fastening means that locks the trim piece to the sheet metal part.

10. The trim piece as claimed in claim 8, further comprising a well.

11. The trim piece as claimed in claim 8, further comprising a second attachment means for attaching a door handle.

12. The trim piece as claimed in claim 8, further comprising a second attachment means for attaching another door trim piece.

13. The trim piece as claimed in claim 11, further comprising a third attachment means for attaching another door trim piece.

14. A motor vehicle door comprising:
a trim piece as claimed in claim 8.

15. A motor vehicle comprising:
a door as claimed in claim 14.
